(19) United States
(12) Patent Application Publication
(10) Pub. No.: US 2005/0114698 A1
(43) Pub. Date: May 26, 2005

(54) Remote control protocol for a local action to generate a command message

(76) Inventors: Jean-Pierre Vigarie, Cesson Sevigne (FR); Claudia Becker, Rennes (FR); Andre Codet, Rennes (FR); Pierre Fevrier, Sulpice La Foret (FR); Chantal Guionnet, Cesson Sevigne (FR)

Correspondence Address: STITES & HARBISON PLLC, 1199 NORTH FAIRFAX STREET, SUITE 900, ALEXANDRIA, VA, 22314, US

(21) Appl. No.: 10/502,598

(22) PCT Filed: Jan. 21, 2003
(86) PCT No.: PCT/FR03/00193

(30) Foreign Application Priority Data
Jan. 28, 2002 (FR) 02/00990

(51) Int. Cl. H04L 9/00

(52) U.S. Cl. 713/201

(57) ABSTRACT

The invention relates to a remote control protocol for a local action to generate a command message (OM), which permits a broadcaster to control a local action in at least one receiving station comprising: a step for transmission of an authorisation message (HM) from the broadcaster to the receiving station(s) and a verification step (4) in said receiving station(s), for transmitted authenticity parameters and addresses, with regard to parameters memorised in each of said receiving stations. The invention is characterised in that the authorisation message (HM) comprises a generation action (CM), at the level of the receiving station(s), a command message (OM), calculated locally and said protocol also comprises, conditional on the verification step (4), an interpretation step (10) of said action (CM) transmitted with said authorisation message (HM) and a local generation step (20) for a command message (OM) in response to said interpretation step (10). The above finds application particularly in transmission of encoded television information (I*).

The present invention relates to a remote control protocol for a local action for generating a command message and recording and retransmission devices using such a protocol.

Control techniques of this type are used in particular for transmitting information over a network. They allow a transmitter to control the local generation of a command message which will subsequently be executed. Typically, such a command message is generated using local parameters of the receiver.

Such techniques are used in the field of broadcasting television programmes with conditional access, under the terms of “transcontrol”, as is described in French patents FR-A-90 07 165 and FR-A-96 10 302.

The techniques described in these documents allow an enabled receiver to replace a service message which is associated with scrambled information with a new message calculated locally. This allows in particular a new encryption of control words to be carried out after they have been unencrypted, using local parameters.

However, these techniques present major problems in terms of security of use.

The initial transmitter has only limited control over the use of the control words received which allow the information to be managed at the receiver location.

Consequently, when information is recorded or retransmitted, the initial transmitter or broadcasting transmitter is not in control of the use which is made of the information associated with the locally calculated command message.

Similarly, within the scope of a transmission by way of satellites to retransmission stations, each station must comprise means for accessing and converting all of the information transmitted.

For example, these are security processors, each integrated in a card containing high-level enabling codes.

Owing to the multiplicity thereof, however, it is difficult to ensure the physical security of these pieces of equipment in the retransmission stations.

Therefore, it is apparent that the existing equipment poses specific problems in terms of security of use.

The object of the invention is to solve these problems concerning security of use by allowing a transmitter to control, partially or even totally, the use made of received information by a receiver.

The present invention relates to a remote control protocol for an action to generate locally a command message, from a broadcasting transmitter, in order to control a local action at at least one receiving station, comprising at least a decoding terminal, an access control module provided with a security processor, the security processor comprising authenticity and address verification parameters which are stored in a store which is associated with the processor, the protocol comprising:
a step for transmitting, from the broadcasting transmitter to the receiving station(s), an enabling message which comprises a field containing authenticity and address parameters and a field containing data; and
a step for verifying, in the receiving station(s), the authenticity and address parameters relative to the parameters stored in each of the receiving stations;
   characterised in that the enabling message comprises, in the data field, an action for generating, at the receiving station(s), a command message which is calculated locally, and in that the protocol comprises, in a manner conditional on the verification step, at least:
a step for interpreting the action transmitted in the enabling message; and
a step for locally generating a command message in response to the interpreting step.

According to other features of the invention:

the data field of the enabling message comprises a plurality of instruction blocks which are arranged in logical combinations of conditions, the binary result of which for the logical verification, true or false, allows a conditional branching to be produced between the blocks and the instructions contained in the blocks to be processed;

the action comprises a field which contains parameters representing the format of the command message to be generated locally, the step for interpreting the action comprising at least a step for taking into consideration the format parameters in order to carry out operations for generating elements of the command message in accordance with these format parameters;

the operations carried out during the interpreting step include encrypting, unencrypting and/or over-encrypting operations;

the format parameters contained in the action comprise references to local parameters which are stored in a store which is non-write-accessible to the users of the terminals, the local parameters being used during the operations of the step for interpreting the action;

the format parameters contained in the action comprise references to local parameters which are stored in a store which is write-accessible to the users of the terminals, the local parameters being used during the operations of the step for interpreting the action;

the action comprises a field which contains enabling parameters, the step for interpreting the action comprising at least a step for generating security parameters in order to define security parameters for the command message, at least on the basis of the enabling parameters and in accordance with the operations required in carrying out the step for taking into consideration the format parameters;

the action comprises a field which contains data, the step for interpreting the action comprising at least a step for processing data in order to define data of the command message, at least on the basis of the data contained in the data field of the action and in accordance with the operations required in carrying out the step for taking into consideration the format parameters;

the data field of the action comprises a plurality of instruction blocks which are arranged in logical combinations of conditions, the binary result of which for the logical verification, true or false, allows a conditional branching to be produced between the blocks and the instructions which they contain to be processed;

the generating step transmits a command message which comprises a field containing security parameters and a field containing data;

the data field of the command message comprises a plurality of instruction blocks which are arranged in logical combinations of conditions, the binary result of which for the logical verification, true or false, allows a conditional branching to be produced between the blocks and the instructions which they contain to be processed;

the protocol comprises, in addition to the step for locally generating a command message, a step for carrying out this command message;

the step for carrying out the command message comprises the verification of security parameters contained in the command message and reading then processing data contained in the command message;

the locally generated command message is an enabling message, as defined above;

the broadcasting transmitter being suitable for transmitting scrambled information by means of a service key which is contained in a control word, the transmission of the scrambled information being accompanied by the transmission of a cryptogram of the control word, which is encrypted by means of an operation key, the decoding terminal of each receiving station then constituting a terminal for unscrambling the scrambled information and comprising, in the security processor of the control module, the operation key in order to reconstitute, from the operation key and the encrypted control word, the service key contained in the control word, each unscrambling terminal allowing, on the basis of the reconstituted service key, the scrambled information to be unscrambled, the enabling message is transmitted by multiplexing in the flow of scrambled information transmitted from the broadcasting transmitter to the receiving station(s);

the data field of the action comprises at least the cryptogram of the control word;

the data field of the action comprises instructions for replacing the enabling message, which is multiplexed with the scrambled information, with the locally generated command message, and the step for locally generating a command message is followed by a step for replacing the enabling message with the command message in the scrambled information;

it comprises a step for recording, on a non-volatile carrier, the scrambled information which is multiplexed with the locally generated command message;

the security-parameters and/or the data of the command message comprise(s) criteria for access to the scrambled information which is recorded on the non-volatile carrier, the protocol further comprising:

a step for requesting access to the scrambled and recorded information; and

a step for verifying the access criteria of the command message in order to transmit, upon verification of these access criteria, an authorisation for access to the recorded scrambled data;

the access criteria are selected from the parameters in the group constituted by the following parameters:
an enabling level of the terminal;
a limit date for access authorisation;
a defined duration relative to a date and/or time;
a service life; and
a maximum number of authorised access requests;

it comprises a step for retransmitting the scrambled information, which is multiplexed with the locally generated command message, from the receiving station(s) to one or more secondary receiving stations; and

all or part of the enabling message is encrypted before the transmission step in order to ensure the confidentiality of this transmission, the step for verifying the authenticity and address parameters being associated with a step for unencrypting this enabling message.

The invention also relates to a decoding and recording terminal comprising a decoder which is associated with a security processor which is integrated, for example, in a removable card comprising a microprocessor and a store which is non-write-accessible to a user, the terminal further comprising a non-volatile carrier for recording information, characterised in that it is suitable for using a protocol as described above.

The invention further relates to a decoding and retransmitting terminal comprising a decoder which is associated with a security processor or such a removable card comprising a microprocessor and a store which is non-write-accessible to a user, the terminal further comprising means for retransmitting information, characterised in that it is suitable for using a protocol as described above.

The invention will be better understood from a reading of the description below, given purely by way of example with reference to the appended drawings, in which:

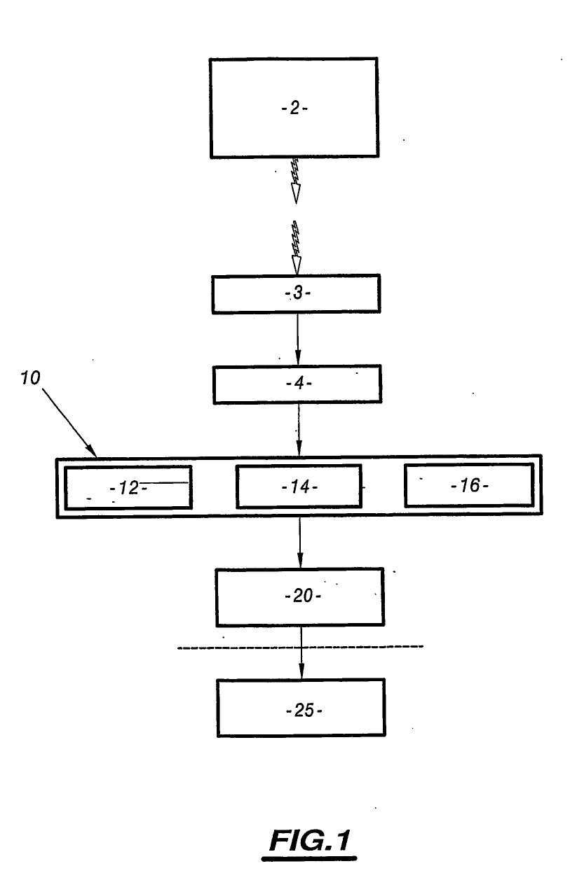

FIG. 1 is a schematic flow chart of the protocol of the invention;

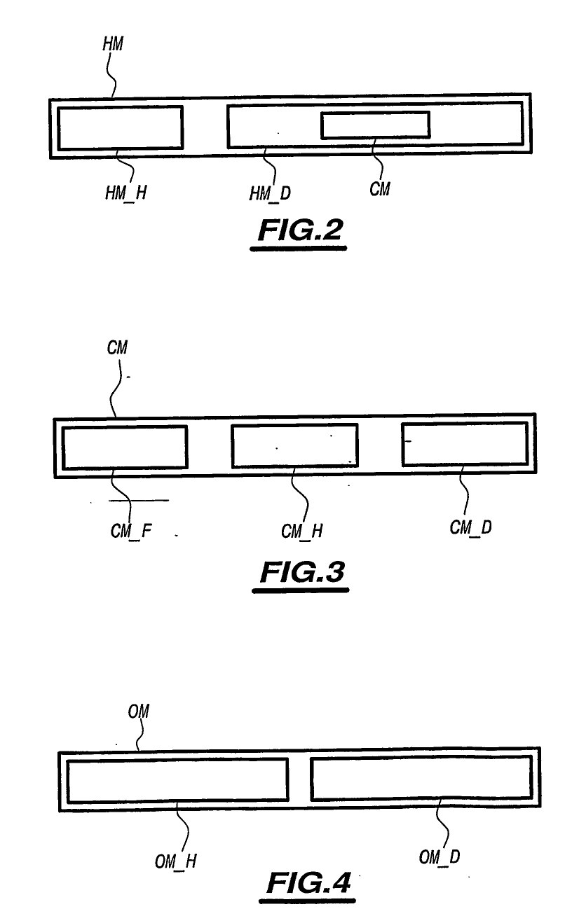

FIGS. 2, 3 and 4 are schematic representations of the format of the messages used in the protocol of the invention;

FIG. 5 is a schematic illustration of the conventional transmission of scrambled information;

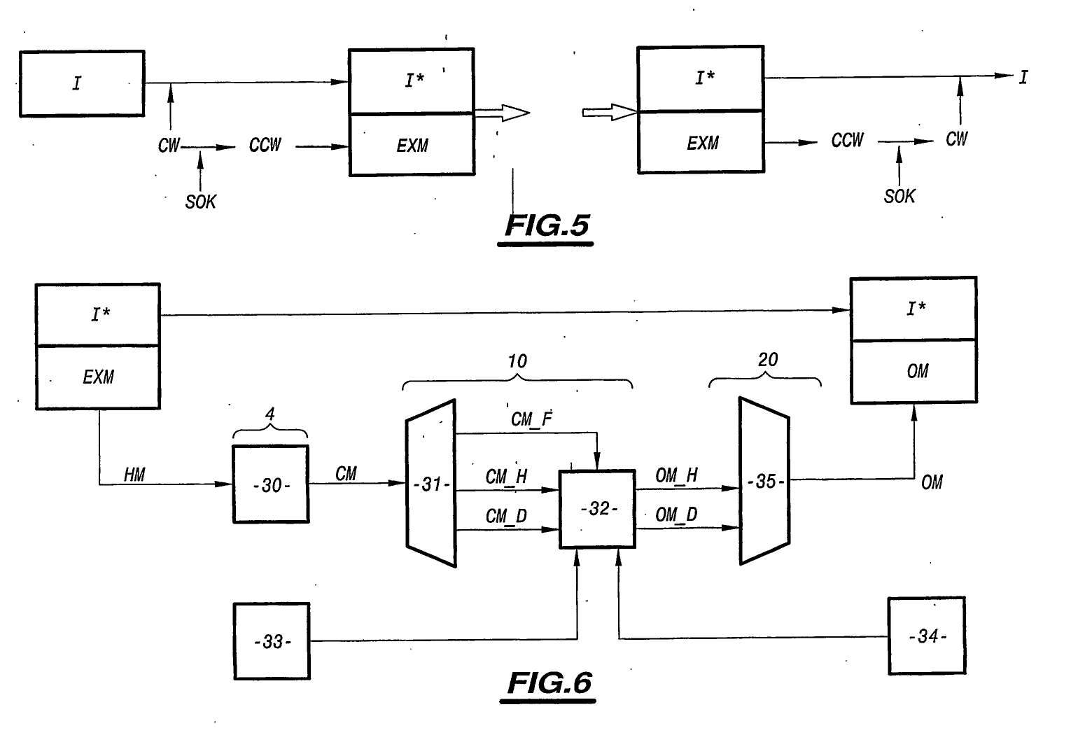

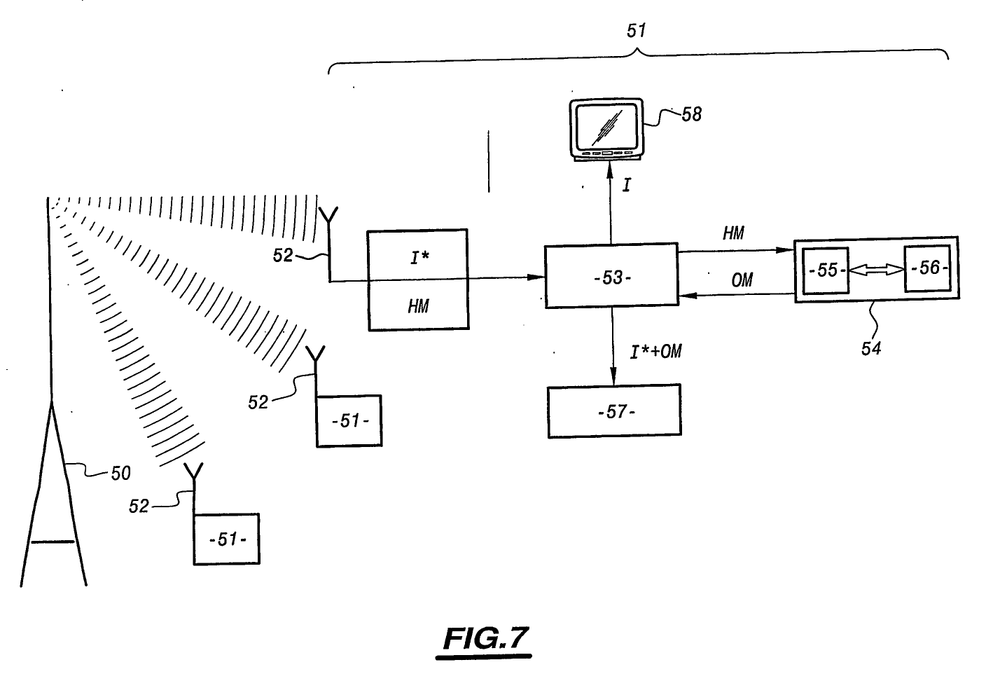

FIG. 6 is a schematic illustration of the receiving and processing operations for scrambled information according to the invention;

FIG. 7 is a block diagram of a recording system using the invention; and

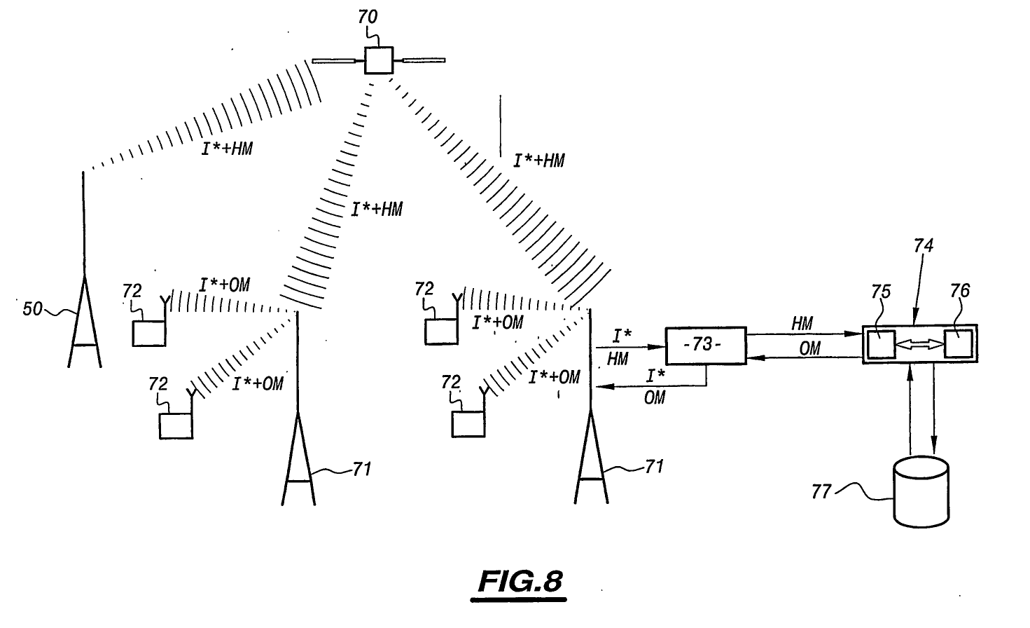

FIG. 8 is a block diagram of a retransmission system using the invention.

FIG. 1 is a flow chart showing the main steps of the remote control protocol for a local action to generate a command message according to the invention.

The protocol starts with a step 2 for transmitting an enabling message designated HM from a broadcasting transmitter to one or more receiving station(s).

This enabling message HM comprises, as is illustrated with reference to FIG. 2, a field HM_H containing authenticity and address parameters and a data field HM_D.

According to the invention, the data field HM_D further comprises a field containing an action CM for generating, at the receiving station(s), a command message designated OM.

With reference to FIG. 1, it will be appreciated that, after transmission step 2, the protocol comprises a receiving step 3 then a step 4 for verifying the authenticity and the address of the recipients of the enabling message HM.

This step 4 is carried out conventionally and verifies that the message transmitted has not been altered and that the receiving station(s) are the intended recipients of this message and are authorised to process it.

If the authenticity and address parameters are verified, the receiving station(s) read(s) then process(es) the data field HM_D.

In a conventional manner, the data field HM_D can be organised into a plurality of blocks arranged in logical combinations of conditions, the binary result of which for the logical verification, true or false, allows functional branchings to be produced between the blocks.

Each block can comprise actions or lists of actions to be carried out.

Typically, the field HM_D can be arranged according to a structured logical phrase containing the following logical relationship:
if: the conditional logic expression is verified;
then: the action or list of actions described in the block for this situation or the list of actions associated with the verified condition is carried out; and
else: the action or the list of actions described in the descriptive block for the action or list of actions associated with this non-verified condition is carried out.

The data field HM_D contains at least, and optionally only, the action CM for generating the command message OM at the receiving station(s).
With reference to FIG. 3, the detail of the format of the action CM for generating a command message is described. CM contains a field CM_H containing enabling parameters, a field CM_F containing format parameters and a field CM_D containing data.

During an interpreting step 10, the action CM is interpreted in order to generate all the elements necessary for the local generation of the command message OM.

To this end, the step 10 for interpreting the action CM can comprise a step 12 for taking into consideration format parameters of the field CM_F in order to define the format of the command message OM and, in this manner, to define the operations to be carried out in order to generate it.

The interpreting step 10 can further comprise a step 14 for generating security parameters in order to define security parameters for the command message OM, at least on the basis of the enabling parameters contained in the field CM_H of the action CM and in accordance with the operations required in applying the format parameters of the field CM_F.

Finally, the interpreting step 10 can also comprise a step 16 for processing the data of the field CM_D in order to define data of the command message OM, at least on the basis of the data contained in the field CM_D of the action CM and in accordance with the operations required in applying the format parameters of the field CM_F.

All of the elements defined during step 10 for interpreting the action CM are then used to carry out the step 20 for locally generating the command message OM.

FIG. 4 illustrates the detail of the command message OM as generated at the end of the step 20.

This message OM comprises a field OM_H containing the security parameters defined during the step 14 and a field OM_D containing the data defined during the step 16.

Immediately or subsequently, the command message OM is carried out during an execution step 25, during which the security parameters of the field OM_H are verified and the data field OM_D is read then processed.

In this manner, the command message OM generated locally at the receiver(s) constitutes a command message which is intended for immediate or subsequent use and all or part of the type of which has been defined by the transmitter of the enabling message HM.

Owing to the step 12, the message OM complies with the format specified in the field CM_F of the action CM.

Similarly, the security parameters and the data of the command message OM are defined by carrying out operations which are indicated by the format parameters specified in the field CM_F, at least on the basis of the enabling parameters defined in the field CM_H and the data contained in the field CM_D of the action CM.

Therefore, it will be appreciated that the broadcasting transmitter, in defining the action CM contained in the enabling message HM, defines all of the elements used during the step 20 for generating a local message and, in this manner, retains control over the generation of the command message OM.

Advantageously, in the manner of the data field HM_D, the data field CM_D of the action CM contains instructions or lists of instructions which are themselves arranged in logical combinations according to structured logical phrases.

At the end of the generation step 20, the command message OM contains, in the field OM_D, all or some of the data of the field CM_D so that the command message OM also contains instructions or lists of instructions which are arranged in logical combinations, which will be carried out during the step 25 for carrying out the command message OM.

Optionally, the command message OM generated at the end of the step 20 constitutes an enabling message of the type of the message HM described above and the execution thereof during the step 25 leads to the generation of a second command message.

The operation of the protocol of the invention will now be described in greater detail with reference to the transmission of scrambled television information.

In the transmission of television information, there are conventionally messages referred to as EXM which are generic control messages and/or response messages which can be divided into specific messages, such as access control messages, referred to as ECM, or access entitlement management messages, referred to as EMM, or any other specific management message, as is described in the above-cited patents.

Within the scope of the application of the invention to the transmission of scrambled television information, an enabling message HM as defined above can have a dual function and, at the same time, be an enabling message and a message of the EXM type.

With reference to FIG. 5, the basic principle of the transmission of scrambled information is described in greater detail.

The information I is scrambled by means of a service key contained in a control word CW in order to transmit scrambled information I*.

The control word CW is encrypted by means of a service key SOK in order to transmit a cryptogram CCW of the control word.

The cryptogram CCW is inserted in a message of the EXM type which is multiplexed with the scrambled information I* in the flow of information.

Upon receipt, the information I* and the service message EXM are de-multiplexed in order to extract the message EXM containing the cryptogram CCW of the control word.

By means of the operation key SOK, which is stored at the receiving station, the cryptogram CCW of the control word is unencrypted in order to obtain the control word CW containing the service key which allows the information I* to be unscrambled and the information I to be reconstituted.

FIG. 6 shows the application of the protocol of the invention to the receipt of scrambled information.

This Figure schematically illustrates the elements of a receiving station which takes action when an enabling message is received.

This receiving station comprises a module 30 for verifying the authenticity and address parameters, which module 30 is connected to a de-multiplexer 31 which is itself connected to a calculation module 32. The module 32 is also connected to a store 33 which is non-write-accessible to a user of the receiving station and a store 34 which is write-accessible to such a user.

The output of the calculation module 32 is connected to a multiplexer 35 which transmits the command message OM.

Upon receipt, the scrambled information I* is de-multiplexed and the enabling message HM is separated.

After receipt, the receiving station carries out the step 4 for verifying the authenticity and address parameters by means of the verification module 30 of conventional type.

At the output of the module 30, the action CM is extracted from the data field HM_D and is introduced into the demultiplexer 31 which outputs the enabling parameters contained in the field CM_H, the data contained in the field CM_D and the format parameters contained in the field CM_F, for the attention of the calculation module 32 which carries out the step 10 for interpreting the action CM.

In accordance with the format parameters CM_F, the calculation module 32 carries out different operations on enabling parameters contained in the field CM_H and on data contained in the field CM_D.

Similarly, in accordance with these parameters, the calculation module 32 carries out operations which use parameters stored at the receiving station.

In this case, the format parameters of the field CM_F or enabling parameters of the field CM_H refer to local parameters by means of, for example, a system of storage addresses.

For example, these operations use parameters which are recorded in the store 33 which is non-write-accessible to a user of the receiving station.

The calculation module 32 can also use parameters recorded in the store 34 which is write-accessible to a user of the receiving station.

In this manner, the calculation module 32 can unencrypt the data contained in the field CM_D before re-encrypting them with parameters specific to the receiving station.

For example, when sent, the cryptogram of the control word CCW is integrated in the data field HM_D of the enabling message HM, which is then multiplexed with the scrambled information I*. In this manner, upon receipt, unencrypting then re-encrypting operations can be applied to the cryptogram CCW of the control word.

Once the step 10 has been completed, the calculation means 32 transmit elements which constitute the security parameters as well as the data of the command message OM.

All of these parameters and data are sent to the multiplexer 35 which carries out step 20 for generating a command message and transmits the command message OM, which is re-multiplexed with the scrambled information I*.

In this manner, the enabling message HM is replaced by the command message OM which is generated locally in accordance with the action CM defined by the transmitter and transmitted in the enabling message HM.

Two specific methods of carrying out the protocol of the invention will now be described with reference to FIGS. 7 and 8.

In a general manner, FIG. 7 illustrates a system for transmitting scrambled information with control of the recording.

Such a system comprises a broadcasting transmitter 50 and a plurality of receiving terminals 51.

The terminals 51 comprise at least one receiving antenna 52, by way of which they receive scrambled information I* which is multiplexed with an enabling message HM.

Each terminal 51 comprises, at the input, a decoder 53 which is associated with a security processor. The security processor can be integrated in a removable smart card 54 which comprises a microprocessor 55 and a non-volatile store 56 which is non-write-accessible to a user of the terminal 51, in which store at least a copy of the operation key SOK used during the encryption of the control word CW is stored.

Preferably, the store 56 is also not read-accessible.

The transmitter 50 transmits, in conventional manner by radio waves, a scrambled television programme I* to the receiving terminals 51.

Upon receipt, the decoder 53 separates the enabling message HM from the scrambled information I* and sends the enabling message HM, for processing, to the microprocessor 55 of the removable card 54.

The microprocessor 55 then carries out the step 4 of the method and carries out the conventional authenticity and address verification operations. This verification step 4 is based on a comparison of the parameters sent with local fixed parameters which are stored in the store 56.

Before being transmitted by the broadcasting transmitter 50, all or part of the enabling message HM is advantageously encrypted in order to be made confidential. In this case, the step 4 for verifying authenticity is associated with a step for reconstituting the message HM.

For example, only the authenticity parameters are not encrypted so that the reconstituting step is carried out in a manner conditional on the step 4 being carried out.

In this manner, the same enabling message can be intended for a single terminal or a group of terminals in accordance with the address parameters.

If the verification step 4 is positive, the microprocessor 55 begins the step 10 for interpreting the action CM.

For example, the format parameters of the field CM_F indicate a calculation to be carried out on data of the field CM_D by means of the enabling parameters of the field CM_F and local parameters stored in the store 56. Typically, this calculation consists in unencrypting the cryptogram CCW of the control word by means of the SOK key, then in re-encrypting it with a local encryption key which is stored in the store 56 of the microprocessor 55.

If necessary, over-encrypting of the cryptogram CCW can be carried out or any other conversion thereof.

Preferably, the encrypting and unencrypting operations are carried out only in the microprocessor 55 so that the control word CW is never accessible to a user of the receiving station.

In this manner, the microprocessor calculates security and data parameters to be associated with the command message OM.

Consequently, the microprocessor 55 carries out the step 20 for locally generating the command message OM with the above-defined elements being assembled in order to transmit the message OM.

The message OM which is output then comprises, within the data field OM_D, the new cryptogram of the control word which is encrypted with a local key stored in the microprocessor 55 which carries out the operation.

Subsequently, the message OM is multiplexed once more with the scrambled information I* and is stored on a non-volatile carrier 57 for recording information, such as a video cassette.

In this manner, the command message is de-multiplexed then carried out when the scrambled information I* recorded is accessed once more.

This execution comprises the verification of the security parameters of the field OM_H, then the decoding of the data field OM_D. The cryptogram of the control word, which can be unencrypted by means of the processor 55 which is used when the information is received, is located in this field.

When the key used during the re-encrypting is specific to the microprocessor 55, only it can carry out the unencrypting of the cryptogram and extract from it the control word in order to gain access to the scrambled information I*.

Similarly, if the key used during the re-encryption is specific to a group of receiving stations, only a terminal from this group will be able to gain access to the scrambled information.

Such re-encryption by means of local keys allows the broadcasting transmitter 50, for example, to restrict access to scrambled information or to enable the receiving stations of the operation key SOK to be modified, if necessary.

Each time the recorded scrambled information is accessed again, the message OM is advantageously recalculated and a parameter for use, such as a counter or a limit use date, is used.

For example, the format field CM_F of the generating action CM brings about the insertion of the creation date of the command message OM in the data field OM_D of the command message OM.

Similarly, the data field CM_D of the action CM comprises instructions for verifying this date. When the message OM is generated, the data field CM_D is transferred and constitutes part of the data field OM_D of the command message OM.

In this manner, when the scrambled information I* recorded with the command message OM is accessed once more, the command message OM is executed. After the security parameters of the field OM_H have been verified, the instructions of the field OM_D are carried out and the creation date is verified so that branchings which are conditional according to this date can be carried out.

For example, if the validity criteria of this date are verified, the information I* is unscrambled in order to be displayed on a display medium 58.

In this manner, by means of the protocol of the invention, the transmitter 50 of the message HM manages the use of the information received at the receiving stations, controlling the possibilities for recording and re-reading the scrambled information I* which is multiplexed with the command message OM generated locally in accordance with the parameters transmitted in the action CM of the enabling message HM.

With reference to FIG. 8, a second embodiment of the invention is described in the case of a retransmission system by satellite, terrestrial, optical fibre, coaxial fibre or other means.

By way of example, this system can comprise a broadcasting transmitter 50, a satellite 70, retransmission stations 71 and receiving stations 72.

Each retransmission station 71 can comprise a decoder 73 which is associated with a security processor. This processor can be integrated in a removable card 74 which comprises a microprocessor 75 associated with a store 76 which is non-write-accessible to an operator of the retransmission station 71 comprising at least a copy of the operation key SOK which is used when the control word CW is encrypted.

The stations 71 also comprise databases 77 which store data which are specific to each station 71, such as client codes or specific encryption keys.

The broadcasting transmitter 50 transmits scrambled information I* which is multiplexed with an enabling message HM to the satellite 70 which retransmits this information to the retransmission stations 71.

Upon receipt, the microprocessor 75 carries out the step 4 of the method and carries out the conventional authenticity and address verifications of the message HM. This verification step 4 is based in particular on a comparison of the parameters sent with local parameters stored in the store 76.

In this manner, the same enabling message can be intended for a single terminal or for a group of terminals in accordance with the address parameters.

Should the verification step 4 be found to be satisfactory, the microprocessor 75 begins step 10 for interpreting the action CM.

In this embodiment, the format parameters of the action CM contained in the field CM_F allow local calculation parameters obtained from the database 77 to be used.

By means of these local parameters, format and enabling parameters of the action CM, the processor 75 generates the elements which constitute the command message OM.

For example, the parameters of the field CM_F refer to address codes for clients of this station, which are defined by an operator of the station 71.

During the step 14, the security parameters intended for the field OM_H are calculated by the microprocessor 75 by means of these address codes.

The microprocessor 75 then carries out the step 20 and transmits the message OM for the attention of the decoder 73.

This command message OM is re-multiplexed with the scrambled information I* before being retransmitted to the receiving stations 72.

After the message OM has been separated from the information I*, the receiving stations 72 carry out the step 25 and execute the message OM.

The stations 72 then carry out a verification of the security parameters of the field OM_H, then read and process the data of the field OM_D.

In the example described, the security parameters of the field OM_H contain the address codes and authenticity codes of the clients of the station 71 who have carried out step 10. In this manner, only these clients will be able to comply with the security parameters of the field OM_H and access the data of the field OM_D which contains in particular the cryptogram CCW of the control word which allows the information I* to be unscrambled.

In this embodiment, the transmitter 50, in defining the action CM of the enabling message HM, controls the generation of the command message OM, specifying the references of the local parameters to be used during the calculations of step 10.

Therefore, it will be appreciated that the protocol of the invention generally allows a broadcasting transmitter to retain optimum and variable control over the use of scrambled information by means of the action CM for generating a command message transmitted in the enabling message HM.

Furthermore, the command message generated can also be an enabling message so that the execution thereof brings about the generation of a new command message.

The protocol of the invention has been described with reference to broadcasting of a television programme in order to facilitate comprehension thereof. However, this protocol can also be applied to other fields, in particular the transmission of numerical information over a network.

Similarly, the decoding terminals can be any type of suitable terminal, such as television sets, microcomputers, . . .

The type and the specifications of the components of the terminals, and in particular the arrangement of the decoders, microprocessors and stores, can be adapted depending on the needs and the environment.

Finally, the operations described in the two embodiments set out can be combined and/or modified in order to adapt the protocol of the invention to the desired use.

1. Remote control protocol for an action to generate locally a command message, from a broadcasting transmitter, in order to control a local action at at least one receiving station, comprising at least a decoding terminal, an access control module provided with a security processor, the security processor comprising authenticity and address verification parameters which are stored in a store which is associated with the processor, the protocol comprising:
a step for transmitting, from the broadcasting transmitter to the receiving station(s), an enabling message which comprises a field containing authenticity and address parameters and a field containing data; and
a step for verifying, in the receiving station(s), the authenticity and address parameters relative to the parameters stored in each of the receiving stations,
characterized in that the enabling message comprises, in the data field, an action for generating, at the receiving station(s), a command message which is calculated locally, and in that the protocol comprises, in a manner conditional on the verification step, at least:
a step for interpreting the action transmitted in the enabling message; and
a step for locally generating a command message in response to the interpreting step.

2. Protocol according to claim 1, characterized in that the data field of the enabling message comprises a plurality of instruction blocks which are arranged in logical combinations of conditions, the binary result of which for the logical verification, true or false, allows a conditional branching to be produced between the blocks and the instructions contained in the blocks to be processed.

3. Protocol according to claim 1, characterized in that the action comprises a field which contains parameters representing the format of the command message to be generated locally, the step for interpreting the action comprising at least a step for taking into consideration the format parameters in order to carry out operations for generating elements of the command message in accordance with these format parameters.

4. Protocol according to claim 3, characterized in that the operations carried out during the interpreting step include encrypting, unencrypting and/or over-encrypting operations.

5. Protocol according to claim 3, characterized in that the format parameters contained in the action comprise references to local parameters which are stored in a store which is non-write-accessible to the users of the terminals, the local parameters being used during the operations of the step for interpreting the action.

6. Protocol according to claim 3, characterized in that the format parameters contained in the action comprise references to local parameters which are stored in a store which is write-accessible to the users of the terminals, the local parameters being used during the operations of the step for interpreting the action.

7. Protocol according to claim 3, characterized in that the action comprises a field which contains enabling parameters, the step for interpreting the action comprising at least a step for generating security parameters in order to define security parameters for the command message, at least on the basis of the enabling parameters and in accordance with the operations required in carrying out the step for taking into consideration the format parameters.

8. Protocol according to claim 3, characterized in that the action comprises a field which contains data, the step for interpreting the action comprising at least a step for processing data in order to define data of the command message, at least on the basis of the data contained in the data field of the action and in accordance with the operations required in carrying out the step for taking into consideration the format parameters.

9. Protocol according to claim 8, characterized in that the data field of the action comprises a plurality of instruction blocks which are arranged in logical combinations of conditions, the binary result of which for the logical verification, true or false, allows a conditional branching to be produced between the blocks and the instructions which they contain to be processed.

10. Protocol according to claim 1, characterized in that the generating step transmits a command message which comprises a field containing security parameters and a field containing data.

11. Protocol according to claim 10, characterized in that the data field of the command message comprises a plurality of instruction blocks which are arranged in logical combinations of conditions, the binary result of which for the logical verification, true or false, allows a conditional branching to be produced between the blocks and the instructions which they contain to be processed.

12. Protocol according to claim 1, characterized in that it comprises, in addition to the step for locally generating a command message, a step for carrying out this command message.

13. Protocol according to claim 12, characterized in that the step for carrying out the command message comprises the verification of security parameters contained in the command message and reading then processing data contained in the command message.

14. Protocol according to claim 1, characterized in that the locally generated command message is an enabling message.

15. Protocol according to claim 1, characterized in that the broadcasting transmitter being suitable for transmitting scrambled information by means of a service key which is contained in a control word, the transmission of the scrambled information being accompanied by the transmission of a cryptogram of the control word, which is encrypted by means of an operation key, the decoding terminal of each receiving station then constituting a terminal for unscrambling the scrambled information and comprising, in the security processor of the control module, the operation key in order to reconstitute, from the operation key and the encrypted control word, each unscrambling terminal allowing, on the basis of the reconstituted service key, the scrambled information to be unscrambled, the enabling message is transmitted by multiplexing in the flow of scrambled information transmitted from the broadcasting transmitter to the receiving station(s).

16. Protocol according to claim 10 taken together, characterized in that the data field of the action comprises at least the cryptogram of the control word.

17. Protocol according to claim 15, characterized in that the data field of the action comprises instructions for replacing the enabling message, which is multiplexed with the scrambled information, with the locally generated command message, and in that the step for locally generating a command message is followed by a step for replacing the enabling message with the command message in the scrambled information.

18. Protocol according to claim 17, characterized in that it comprises a step for recording, on a non-volatile carrier, the scrambled information which is multiplexed with the locally generated command message.

19. Protocol according to claim 18, characterized in that the security parameters and/or the data of the command message comprise(s) criteria for access to the scrambled information which is recorded on the non-volatile carrier, the protocol further comprising:
a step for requesting access to the scrambled and recorded information; and
a step for verifying the access criteria of the command message in order to transmit, upon verification of these access criteria, an authorization for access to the recorded scrambled data.

20. Protocol according to claim 19, characterized in that the access criteria are selected from the parameters in the group constituted by the following parameters:
an enabling level of the terminal;
a limit date for access authorization;
a defined duration relative to a date and/or time;
a service life; and
a maximum number of authorized access requests.

21. Protocol according to claim 15, characterized in that it comprises a step for retransmitting the scrambled information, which is multiplexed with the locally generated command message, from the receiving station(s) to one or more secondary receiving station(s).

22. Protocol according to claim 1, characterized in that all or part of the enabling message is encrypted before the transmission step in order to ensure the confidentiality of this transmission, the step for verifying the authenticity and address parameters being associated with a step for unencrypting this enabling message.

23. Terminal for decoding and recording scrambled information comprising a decoder, with which a security processor is associated, characterized in that it further comprises a non-volatile carrier for recording scrambled information, which is multiplexed with a locally generated command message, in accordance with the protocol according to claim 1.

24. Terminal for decoding and retransmitting scrambled in formation comprising a decoder which is associated with a security processor, characterized in that the terminal comprises means for retransmitting scrambled information with a locally generated command message, in accordance with the protocol according to claim 1.
